(19) United States
(12) Patent Application Publication
(10) Pub. No.: US 2006/0282538 A1
(43) Pub. Date: Dec. 14, 2006

(54) Persistent chat data across different sessions

(76) Inventors: Howard Neil Anglin, Austin, TX (US); Daniel E. Morris, Round Rock, TX (US); Frank Anthony Nuzzi, Round Rock, TX (US)

Correspondence Address: Greg Goshorn, P.C., 9600 Escarpment, auite 745-9, AUSTIN, TX, 78749, US

(21) Appl. No.: 11/152,556

(22) Filed: Jun. 14, 2005

(51) Int. Cl. G06F 15/16

(52) U.S. Cl. 709/228

(57) ABSTRACT

Provided is a system and method for persisting data from an instant messaging session. The method includes opening an instant messaging client, connecting with a server hosting an instant messaging service, logging into the server, identifying an instant messaging session as persistent, upon exiting, receiving a message asking whether persistent data should be downloaded to the client; and receiving the persistent data from the instant messaging session. Another embodiment is directed to a computer system including a processor, a memory coupled to the processor, and an instant messaging client configured to run via the processor and memory, the instant messaging client configured to identify predetermined instant messaging sessions as persistent and store the instant messaging session in the memory.

### TECHNICAL FIELD

The present invention relates generally to delivery of electronic messages, referred to as “chat,” and, more specifically, to a system and method for enabling persistent chat data across different sessions in a computing environment.

### BACKGROUND OF THE INVENTION

Computers and use of the Internet are becoming more and more a means of communication. The type of communication possible with a computer includes real time communication, such as voice over IP (VOIP), and real time text messaging, referred to as “chat” messages. A “chat” can be referred to as “instant messaging”, or “IM”. IM messages can be via a private chat room with another individual or group of individuals and can be near real time over the Internet. IM messages are analogous to a telephone conversation but using text-based, not voice-based, communication. Typically, the instant messaging system provides an alert whenever a party on a private list is online. Chat sessions can take place between two or more people.

Before the Internet became popular, many people were already online through the use of bulletin boards and online services. A user wanting to communicate connects to the computer hosting the bulletin board. Once connected to the board, the user navigates through a series of menus to view the board's contents. To reach another board, a user disconnects from the first board and dials into the other one.

At one time, major online services, such as America Online (AOL); Prodigy and CompuServe, were the primary means that users could connect and communicate with each other online on a service operating as a type of bulletin board. Online services provided a complete application that included the communications software necessary for users to connect and communicate. Probably one of the biggest attractions of the online service model is the community that it builds. A company following an online service model can provide its users with the ability to talk in real-time with each other while they are online through the use of chat rooms and instant messages.

A chat room is software that allows a group of people to type in messages that are seen by everyone in the “room,” while instant messages are basically a chat room for just two people.

In the early 1990s, as people began to spend increasing amounts of time on the Internet, creative software developers designed software that could reproduce some of the aspects of an online service. Chat-room software was developed and set up on Web servers.

In November 1996, instant messaging grew through the introduction of “ICQ”, a free instant-messaging utility introduced by Mirablis Corporation. ICQ, is a real-time tool that uses a software application, called a “client” that resides on a user's computer. The client communicates with an ICQ server whenever a user is online and the client is running.

Today, the Internet Engineering Task Force (IETF) is developing a standard protocol for instant messaging, called the Instant Messaging and Presence Protocol. Business users are discovering that instant messaging allows them to have virtual conferences and collaborate on projects very easily.

With the increase in business use of instant messaging, often there is a need to save data from the session. Typically, if data is required to be saved, a party desiring the data must highlight the chat session and paste the data into a word processing file that can be saved on a computer. The word processing file, however, does not enable reinitiating the chat with the same entities previously involved in the chat session. Further, if the number of participants involved in the chat session is large, reinstating the chat session can be tedious. Moreover, the participants involved would each have to individually perform a paste operation to have the data or one of the participants would have to share the data offline through an email, hard copy or the like. The problem is further exacerbated if there are more than a few participants in a chat session, requiring onerous offline communications to get participants the required data. Reinstating a prior session is therefore complicated and inviting past participants is time consuming, especially if the number of participants is an amount that requires notation of each user's name.

What is needed, therefore, is a system and method for enhancing the business use of instant messaging that enables reinstating a prior chat session and automatically invites past participants.

### SUMMARY OF THE INVENTION

Provided is a computer-implemented method and systems for persisting data from an instant messaging session. According to an embodiment, a method includes opening by a client of an instant messaging client, connecting by the client to a server hosting an instant messaging service, logging by the client into the server, identifying an instant messaging session as persistent; upon exiting, receiving a message asking whether persistent data should be stored on the client; and receiving the persistent data from the instant messaging session to a persistent storage location. According an embodiment, the method provides that the persistent data is stored on the server hosting the instant messaging service. The persistent data can be stored in a temporary file. The persistent data can be stored on a device running the instant messaging client. In another embodiment, the persistent data is mirrored on the server. The connecting can include exchanging an IP address and number of a port assigned to the instant messaging chat client. In one embodiment, the device running the instant messaging client has a cache component in a memory configured to hold the persistent data. In one embodiment, the device running the instant messaging client includes dedicated memory for holding the persistent data. In one embodiment, the identifying an instant messaging session as persistent is performed with a browser, the browser being configured to store the persistent data and display the persistent data upon request.

Another embodiment is directed to a computer program product including code for performing acts for persisting data from an instant messaging session, the acts can include opening by a client of an instant messaging client, connecting by the client to a server hosting an instant messaging service, logging by the client into the server, identifying an instant messaging session as persistent, and upon exiting, receiving a message asking whether persistent data should be stored on the client, and receiving the persistent data from the instant messaging session.

In one embodiment, the computer program product provides that the persistent data is stored on the server hosting the instant messaging service.. In another embodiment, the persistent data is stored in a temporary file. Alternatively, the persistent data is stored on a device running the instant messaging client. In one embodiment, the persistent data is mirrored on the server. The connecting can include exchanging an IP address and number of a port assigned to the instant messaging chat client. Further, the computer program product can provide that the device running the instant messaging client has a cache component in a memory configured to hold the persistent data.. The computer program product of claim can further provide that the device running the instant messaging client includes dedicated memory for holding the persistent data. Identifying an instant messaging session as persistent can be performed with a browser, the browser being configured to store the persistent data and display the persistent data upon request.

Another embodiment is directed to a computer system including a processor, a memory coupled to the processor, and an instant messaging client configured to run via the processor and memory, the instant messaging client configured to identify predetermined instant messaging sessions as persistent and store the instant messaging session in the memory. The computer system, in one embodiment can provide that the instant messaging session is stored as a temporary file via a mirroring process.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of an exemplary system architecture that supports the claimed subject matter;

FIG. 2 is a flow diagram illustrating a method in accordance with an embodiment of the present invention.

FIG. 3 is a flow diagram illustrating a method in accordance with an embodiment of the present invention.

FIG. 4 is a flow diagram illustrating a method in accordance with an embodiment of the present invention.

### DETAILED DESCRIPTION OF THE DRAWINGS

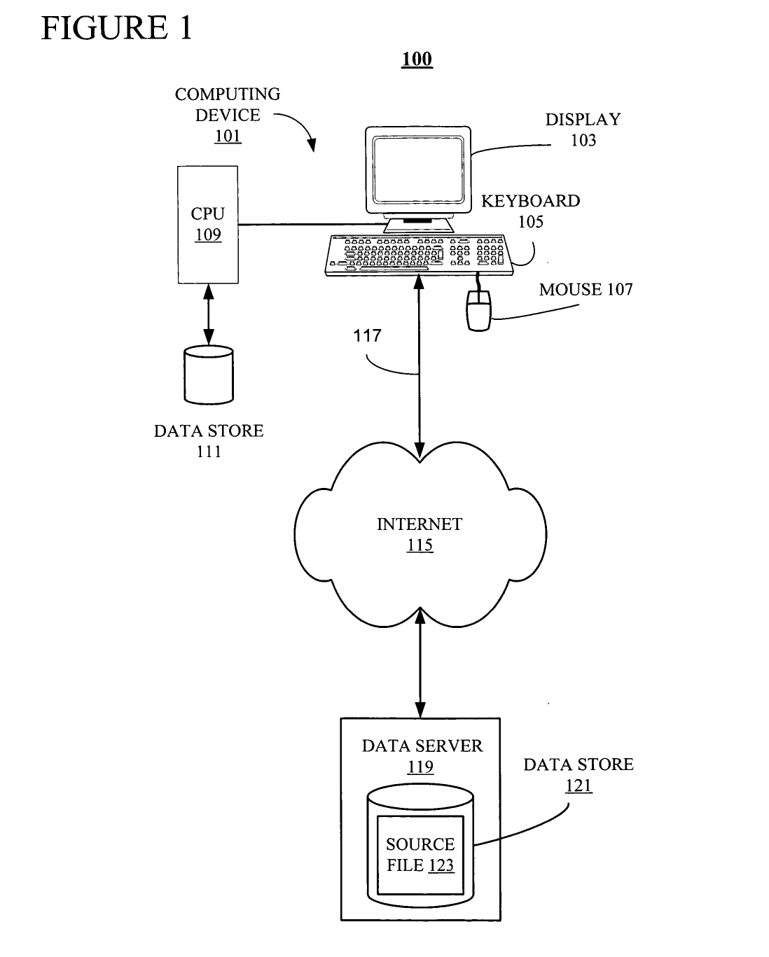

FIG. 1 illustrates an exemplary architecture 100 in which the system according to the present invention is implemented. Those with skill in the computing arts will recognize that the disclosed embodiments have relevance to a wide variety of applications and architectures in addition to those described below. In addition, the functionality of the present invention can be implemented in software, hardware, or a combination of software and hardware. The hardware portion can be implemented using specialized logic; the software portion can be stored in a memory or recording medium and executed by a suitable instruction execution system such as a microprocessor.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

FIG. 1 is a block diagram of an exemplary system architecture that supports the claimed subject matter and includes a general purpose computing device in the form of a computer 100. Components of the computer 100 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 100 typically includes a variety of computer readable media. Computer readable media can be any available media that can be accessed by the computer 100 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137. FIG. 1 is shown with program modules 136 including an instant programming (IM) module in accordance with an embodiment as described herein.

Computer 100 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 100. In FIG. 1, for example, hard disk drive 141 is illustrated as storing operating system 144, application programs 145, other program modules 146 and program data 147. Program modules 146 is shown including an instant messaging module, which can be configured as either located in modules 136 or 146, or both locations, as one with skill in the art will appreciate. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 100 through input devices such as a tablet, or electronic digitizer, 164, a microphone 163, a keyboard 162 and pointing device 161, commonly referred to as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which computer 100 is incorporated, such as in a tablet-type personal computer. In addition, computers such as the computing device 100 may also include other peripheral output devices such as speakers 197 and printer 196, which may be connected through an output peripheral interface 194 or the like.

Computer 100 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 100, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer 100 may comprise the source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 100 is connected to the LAN through a network interface or adapter 170. When used in a WAN networking environment, the computer 100 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to computer 100, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In the description that follows, embodiments are described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the invention is being described in the foregoing context, it is not meant to be limiting as those of skill in the art will appreciate that some of the acts and operation described hereinafter can also be implemented in hardware.

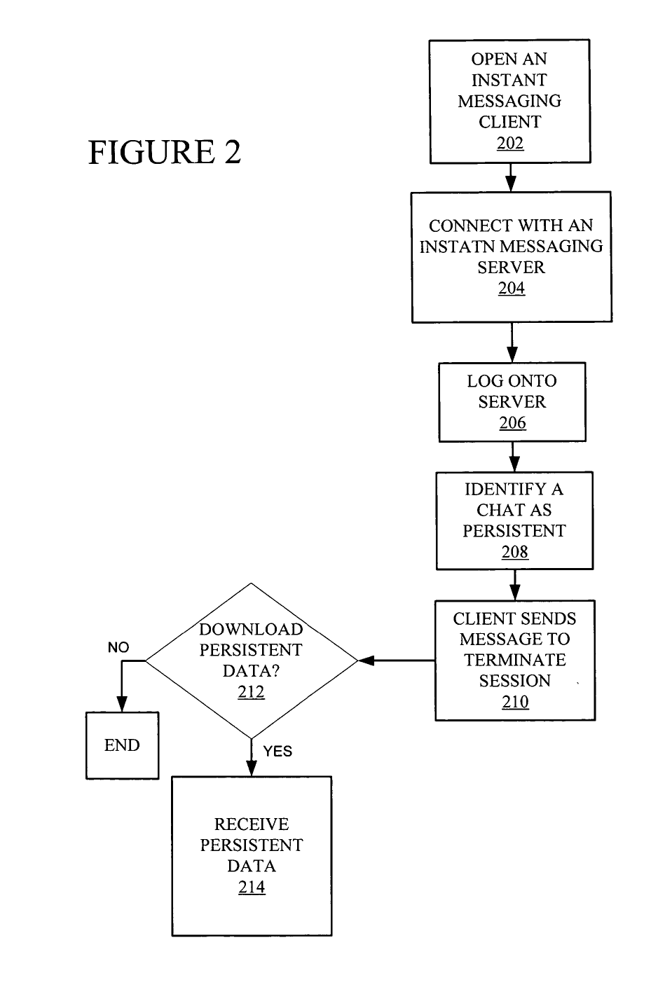

According to an embodiment, computer 100 can be configured as a computer that includes an instant messaging application in accordance with an embodiment. More particularly, referring to FIG. 2, according to an embodiment, a client application provides functionality to load a chat application, send invitations automatically according to a previous chat session, and restore data from a prior chat session.

More particularly, FIG. 2 illustrates a method for operating a client computer to connect with a server with the capability of automatically storing and re-inviting users from a prior session. At 202, the client opens an instant messaging application. At 204, the client connects with an instant messaging server. Once the client connects to the server, at 206, the client logs into the server. To do so, the client sends the server connection information, such as its IP address and number of the port assigned to the chat client.

Concomitant with the client logging into the server or subsequent thereto, the instant messaging server can provide the client with user names present on an associated contacts list stored by instant messaging server The user names can include potential users for the purpose of re-inviting, for initial invitations or those users that were previously automatically stored.

The server creates a temporary file that has the connection information for a user of a client machine and the list of contacts including users that are potential or past chat participants. Users can include machine users, clients or non-machine users. Thus, users can include clients that are identified machines or users that are not identified by a client machine, but can change between different client machines. The server checks to see if any of the users in the contact list are currently logged in and highlights those available for instant messaging. The server then provides the information regarding those users that are logged in by storing the connection information pertaining to those logged-in users. The connection information can include information regarding whether the users are idle, active or the like. The server can send the client connection information to those users on the contact list to the logged-in users. According to an embodiment, the temporary file could be used for more than linking client information. More particularly, the temporary file enables saving data from a chat session to persist chat data. At 208, after logging into the server, the client identifies a chat session as persistent. For purposes of this disclosure, persistent includes persisting data related to a chat session such that the data is saved for later revival in a different session. Once identified as persistent, the instant messaging server begins logging data from the chat session and storing the data on the server in the temporary file. The logging of data can include periodic copying of a chat session screen session, storing all messages, or compressing the messages and storing a compressed version. The chat session can be set up as persistent by a client machine, a user, a chat server or another entity as one with skill in the art with the benefit of the present disclosure will appreciate. For example, a client machine can include a script that automatically designates certain chat sessions as persistent.

In one embodiment, the temporary file includes a mirrored image of the server or another computer, or a “clone” of another computer such that each input on the computer is “mirrored” in the temporary file. Other methods of logging chat data for persistent storage are known and within the scope of the disclosure as one of skill in the art with the benefit of this disclosure will appreciate.

As described above, at 206 when a chat session is set up, the IP address and port number for the computers involved in a chat session are exchanged. The client machine of the user receiving messages from the client can have the IP address and port numbers for those computers in the chat session. Thus, typically, the messages can be sent directly to the client on that recipient's computer. In other words, the server does not need to be involved. All communication is directly between the two clients. For this reason, the messages are “instant messages” in that each party to the chat receives messages instantly and can respond. According to an embodiment, if persistent data is chosen, the temporary file is configured to also mirror what takes place between clients, whether there are two or more clients involved.

When the conversation is complete, a message window including the chat conversation closes. The client can either stay online or the client application can be exited. At 210, upon exiting, the client sends a message to the server to terminate the session. The server can send a message to the client of every party on the contact list to show that a user has logged off. Next, the server typically deletes the temporary file that contained the connection information for the client. However, according to an embodiment, at 212 the client receive a message from the server asking if the client would like to download the persistent data from the temporary file or other storage location on the server. If the client responds that a download is desired, at 214 the client receives the persistent data.

As one of skill in the art will appreciate, the persistent data could also be a function of the client application and present on a client computer such that after a chat session is completed and closed, the application can include a component that acts as the temporary file described above. More particularly, a client computer could have a specialized cache component in memory or the like that can include a module for mirroring data from a chat session.

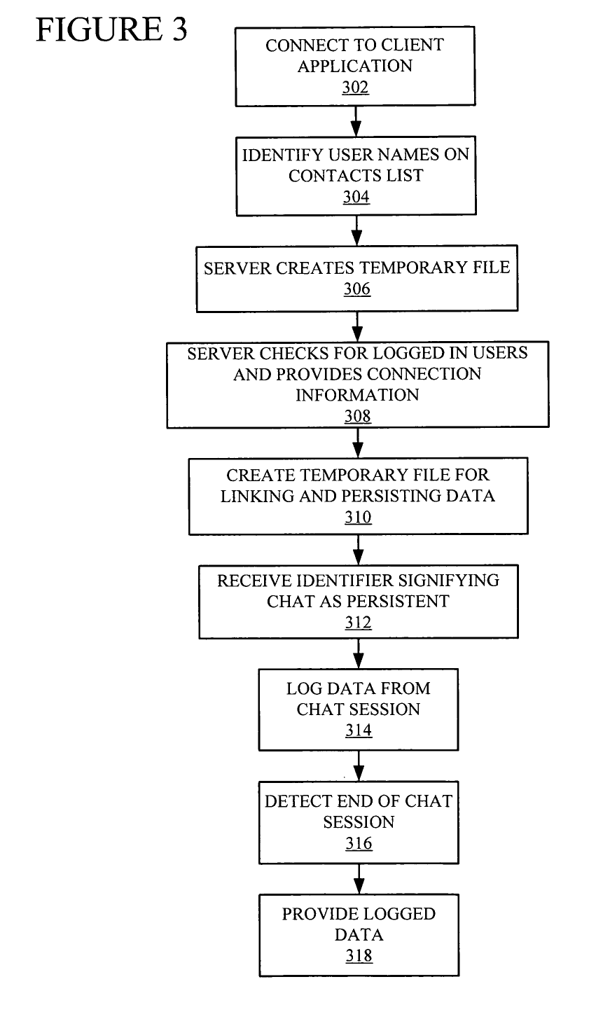

Referring now to FIG. 3, a flow diagram illustrates a method that could be performed by a computer in accordance with an embodiment. The computer can be a server type computer, a client computer or any computer capable of initializing a chat session. More specifically, the computer initializing the chat session can be operated remotely by a user operating another computer, automatically according to a script, or operated directly by a user. A user wishing to initialize a chat session can open a chat application to initialize the chat session. As shown, at 302, the computer with a chat application initializes the chat application. At 304, a chat application running on the computer identifies user names present on a contact list. The contact list provides potential users and client machines available for a chat session. The contact list can be previously stored on the computer locally or be received over a network. At 306 the computer creates a temporary file that has the connection information for the user and the contact list. The temporary file includes the connection information and the contact list to enable recreation of the chat session at a later time. At 308, the computer checks to see if any of the users in the contact list are currently available for the chat session. An available user could include those users that have logged into a chat application over a network or the like. If a user is available, a user name could be highlighted or otherwise depicted as available through a graphical differentiation from users that are not available. An available user that is logged into a chat application provides connection information to enable other users to initiate a chat session. The connection information identifies a specific user via an identifier associated with the user. At 310, the computer creates a temporary file for linking the computer to one or more users on the contact list. The temporary file includes the user-provided connection information and the identifiers associated with the user-provided information. At 312, the computer receives an indication that the chat session should be persistent. The identification can be provided by a user of the computer upon initializing a chat session, can be provided automatically according to rules set up in the chat application, can be provided via a setting that relates to certain chat sessions, or the like. At 314 the computer logs the data from the chat session. The data can include postings from some or all of the chat participants, including postings from chat participants that joined and were present only briefly during a chat session. At 316 the computer receives an indication to end logging the data from the chat session. The end of logging data can include receiving an indication that the chat session is over and each chat participant is no longer available. Alternatively, the end of logging data can include receiving an indication to stop logging data from a chat participant. If the end of logging data can be provided by a chat participant, the logging data can include an authorization to determine which chat participants have authority to determine when logging data is appropriate.

In an embodiment, the computer can be configured to offer to transmit data logged from a chat session to one or more chat participants and/or other users identified as appropriate for receiving the logged data. For example, the computer can query one or more chat participants via the chat session or email other prior chat participants with an option to download logged data. Alternatively, the computer can automatically email each chat participant with a copy of the logged data. Thus, for example, if a business chat session is taking place and a manager needs to log off or any reason, a copy of the complete chat session could become available to the manager from the server, regardless of how long the manager stayed online during the chat session. Thus, at 318 the computer transmits the logged data to chat participants and, optionally, transmits the logged data to chat participants that logged off before the end of the chat session.

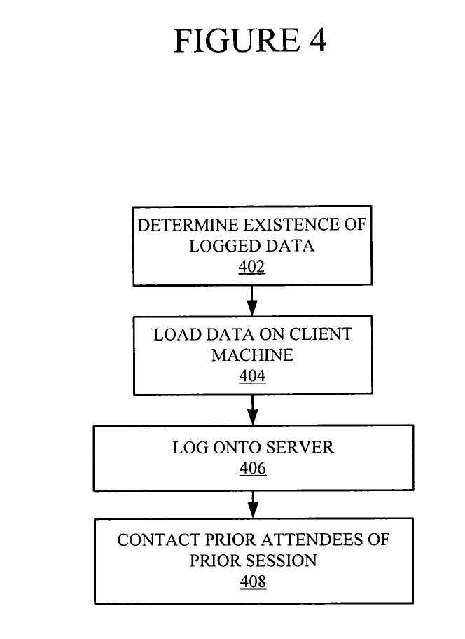

Referring now to FIG. 4, a flow diagram illustrates a method according to an embodiment for restarting a chat session using the logged data provided to users. At 402 a client computer determines that logged data is available. The client computer provides for determining at the client machine, existence of logged data. Block 404 provides for loading the data on a client machine. More particularly, to load the data, the client application for instant messaging is first instantiated, and a module linked to the logged data would enable the loading of the data on the client machine. The loaded data would not require an online presence, but would provide a ghost image of the chat session without the ability to continue the chat session. If a user wants to continue the session, the logged data can include a list of attendees at the prior session. Block 406 provides for logging into a server capable of initiating a chat session. Once online, the list of attendees can resemble a contacts list associated only with the prior chat session. Thus, those attendees who are presently online can be contacted. Block 408 provides for contacting prior attendees of a prior session. Those contacted can be hand picked by a user to include all those available online, can include those online that the user wants to include in the session, and can include new users specifically identified by the user. For example, the attendee list can be configured like a contact list that enables the user to add and delete users according to predetermined criteria. For example, if a new employee needs to catch up on information for a project, the employee can be added to the attendee list and review prior chat sessions to quickly understand the project.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified steps performed in the same or a different order.

We claim:

1. A computer-implemented method for persisting data from an instant messaging session, the method comprising:
opening by a client of an instant messaging client;
connecting by the client to a server hosting an instant messaging service;
logging by the client into the server;
identifying an instant messaging session as persistent;
upon exiting, receiving a message asking whether persistent data should be stored on the client; and
receiving the persistent data from the instant messaging session to a persistent storage location.

2. The computer-implemented method of claim 1 wherein the persistent data is stored on the server hosting the instant messaging service.

3. The computer-implemented method of claim 2 wherein the persistent data is stored in a temporary file.

4. The computer-implemented method of claim 1 wherein the persistent data is stored on a device running the instant messaging client.

5. The computer-implemented method of claim 2 wherein the persistent data is mirrored on the server.

6. The computer-implemented method of claim 1 wherein the connecting includes exchanging an IP address and number of a port assigned to the instant messaging chat client.

7. The computer-implemented method of claim 1 wherein the device running the instant messaging client has a cache component in a memory configured to hold the persistent data.

8. The computer-implemented method of claim 1 wherein the device running the instant messaging client includes dedicated memory for holding the persistent data.

9. The method of claim 1 wherein the identifying an instant messaging session as persistent is performed with a browser, the browser being configured to store the persistent data and display the persistent data upon request.

10. A computer program product comprising code for performing acts for persisting data from an instant messaging session, the acts including:
opening by a client of an instant messaging client;
connecting by the client to a server hosting an instant messaging service;
logging by the client into the server;
identifying an instant messaging session as persistent;
upon exiting, receiving a message asking whether persistent data should be stored on the client; and
receiving the persistent data from the instant messaging session.

11. The computer program product of claim 10 wherein the persistent data is stored on the server hosting the instant messaging service.

12. The computer program product of claim 11 wherein the persistent data is stored in a temporary file.

13. The computer program product of claim 10 wherein the persistent data is stored on a device running the instant messaging client.

14. The computer program product of claim 11 wherein the persistent data is mirrored on the server.

15. The computer program product of claim 10 wherein the connecting includes exchanging an IP address and number of a port assigned to the instant messaging chat client.

16. The computer program product of claim 10 wherein the device running the instant messaging client has a cache component in a memory configured to hold the persistent data.

17. The computer program product of claim 10 wherein the device running the instant messaging client includes dedicated memory for holding the persistent data.

18. The computer program product of claim 10 wherein the identifying an instant messaging session as persistent is performed with a browser, the browser being configured to store the persistent data and display the persistent data upon request.

19. A computer system comprising:
a processor;
a memory coupled to the processor; and
an instant messaging client configured to run via the processor and memory, the instant messaging client configured to identify predetermined instant messaging sessions as persistent and store the instant messaging session in the memory.

20. The computer system of claim 19 wherein the instant messaging session is stored as a temporary file via a mirroring process.
